(19) United States
(12) Patent Application Publication
(10) Pub. No.: US 2009/0315215 A1
(43) Pub. Date: Dec. 24, 2009

(54) MOLDING MOLD AND MANUFACTURING METHOD OF MOLDED PRODUCT

(75) Inventors: Hisashige Uebayashi, Shizuoka (JP); Hiroaki Nagashima, Shizuoka (JP); Hiroaki Izumi, Shizuoka (JP)

Correspondence Address: DARBY & DARBY P.C., P.O. BOX 770, Church Street Station, New York, NY, 10008-0770, US

(73) Assignee: Suzuki Motor Corporation, Hamamatsu-shi (JP)

(21) Appl. No.: 12/421,131

(22) Filed: Apr. 9, 2009

(30) Foreign Application Priority Data
Jun. 24, 2008 (JP) 2008-165008

(51) Int. Cl. B29C 45/27

(52) U.S. Cl. 264/299; 425/542

(57) ABSTRACT

A molding mold includes a runner to fill a molding material from a sprue to a cavity, the runner including a bent portion, in which a cross-sectional area of a flow channel passing through an inner side of the bent portion and a cross-sectional area of a flow channel passing through an outer side of the bent portion are different from each other in at least one region along the runner from the bent portion to the cavity.

### CROSS-REFERENCE TO RELATED APPLICATIONS

This application is based upon and claims the benefit of priority of the prior Japanese Patent Application No. 2008-165008, filed on Jun. 24, 2008, the entire contents of which are incorporated herein by reference.

### BACKGROUND OF THE INVENTION

1. Field of the Invention

The present invention relates to a mold for molding a molded product and a manufacturing method of the molded product. In particular, it is preferable to be used when a ring-shaped molded product or a molded product having an opening, or the like on which a weld line is to be generated is molded.

2. Description of the Related Art

Conventionally, there has been known a manufacturing method of a molded product in which a molding mold is used when the same molded products are molded in large quantities.

Here, there will be explained a molding mold used when, for example, ring-shaped molded products are molded by multi-cavity molding with reference to FIG. 7. Here, there will be explained the case when a molten resin is used as a molding material to be filled in the molding mold. FIG. 7 is a perspective view of one mold (a movable mold side or a fixed mold side) of the conventional molding mold. Note that FIG. 7 shows a sprue 101 provided in the other mold (movable mold side or fixed mold side), which is not shown, with dotted lines.

A mold 100 is structured including a main runner 102, branch runners 103 (103a to 103d), gates 104 (104a to 104d), and cavities 105 (105a to 105d). Each of the main runner 102 and the branch runners 103 is formed in a trapezoidal cross-sectional shape having a draft angle. Note that the draft angle is small here, and thereby the trapezoidal cross-sectional shape will be referred to as an approximately rectangular cross-sectional shape hereinafter. Further, it is formed such that a width W and a height H of the cross-sectional shape of the main runner 102 and each branch runner 103 are approximately the same in dimension. It is noted that the width W and the height H are not limited to be approximately the same dimension but they may be different in dimension. Here, when the molded product is molded, an injection molding machine injects the molten resin to the main runner 102 through the sprue 101 in a state where one mold (the mold 100) and the other mold, which is not shown, are in a close contact with each other.

The molten resin is branched from the main runner 102 into each of the branch runners 13 (103a to 103d), and then it is filled in each of the cavities 105 (105a to 105d) through each of the gates 104 (104a to 104d). The molten resin is fully filled in each of the cavities 105 (105a to 105d) to be solidified, after that, a plurality of the ring-shaped molded products formed in the cavities 105 (105a to 105d) can be manufactured by one mold and the other mold being released. When one mold and the other mold are released, the plural ring-shaped molded products are in a state where portions molded by the main runner 102, the branch runners 103 (103a to 103d), and the gates 104 (104a to 104d) are connected thereto.

Next, there will be explained details of which the molten resin flows from the main runner 102 through each branch runner 103 (103a to 103d) and each gate 104 (104a to 104d), and is filled in each cavity 105 (105a to 105d) with reference to FIG. 8. FIG. 8 is a partial plan view of the mold 100. Here, among the cavities 105 shown in FIG. 7, the cavity 105d will be shown to be explained.

Firstly, the molten resin injected from the sprue 101 flows through the main runner 102 as shown by an arrow A, and flows to a bent portion 106b where the main runner 102 and the branch runner 103d intersect with each other at an angle of 90 degrees. The resin flowed to the bent portion 106b flows from the main runner 102 to the branch runner 103d along the bent portion 106b in a bending manner. At this time, the time for the resin to be filled differs in an inner side and an outer side of the bent portion 106b. Concretely, as shown by an arrow B in FIG. 8, the resin flowing through the inner side of the bent portion 106b is instantly filled in the inner side of the bent portion 106b, and thereby it is filled fast. On the other hand, as shown by an arrow B′, the resin flowing through the outer side of the bent portion 106b takes a longer way than the resin flowing through the inner side of the bent portion 106b, and thereby, it takes a longer time to be filled. The difference between the times for the resin to be filled is due to molding conditions (in particular an injection speed) of the injection molding machine, and the like.

As above, the resins with which the difference arises between the times for the resin to be filled in the inner side and the outer side of the bent portion 106b then flow through the branch runner 103d, and reach the gate 104d respectively by the time difference. Next, between the resins reached the gate 104d, the resin that flows through the inner side of the bent portion 106b flows into the cavity 105d in an arrow C direction shown in FIG. 8, on the other hand, the resin that flows through the outer side of the bent portion 106b flows into the cavity 105d in an arrow direction C′ shown in FIG. 8. Here, the resin flowing in the arrow direction C is the resin that flows through the inner side of the bent portion 106b, and therefore, it reaches the gate 104d faster than the resin that flows through the outer side of the bent portion 106b. Thus, the resin flowing in the arrow C direction is filled faster than the resin flowing in the arrow C′ direction. As a result, the resin that flows in the arrow C direction joins the resin that flows in the arrow C′ direction at a joint line 107, which is shifted toward the side where the resin flows in the arrow C′ direction from a symmetrical position 108 (midpoint) of the cavity 105d. The joint line 107 is called a weld line. Here, although the designer of the mold desires to make the weld line occur at the symmetrical position 108 of the cavity 105d, it is generated at an asymmetrical position.

The above weld line deteriorates an appearance of the molded product molded, and therefore, there is need to make the weld line less visually recognized by having the weld line generated on a parting line of the molded product, or at a slit provided in terms of design or purposefully. However, it is difficult to make the weld line, which is not straight but curved, or the weld line generated at the unintended asymmetrical position on the molded product as described above occur on the parting line or at the slit.

Conventionally, in order to make the above-described curved weld line occur straight, or make the above-described weld line generated at the asymmetrical position occur at a symmetrical position, changing the molding conditions (in particular, injection speed) has been applied. For example, the time for the resin to be filled in the inner side of the above-described bent portion 106b and the time for the resin to be filled in the outer side of the above-described bent portion 106b have been controlled by changing the molding conditions. Further, the weld line has been made to be generated at a designed position of each cavity 105 by, for example, changing a thickness of the molded product itself, or changing a gate position as disclosed in Patent Document 1.

[Patent Document 1] Japanese Patent Application Laid-open No. Hei 9-131767

However, in the case when a range of the molding conditions is narrow, the molding conditions cannot be changed, or the thickness of the molded product itself cannot be changed because uniformity of portion weight balance of the molded product is essential, it is not possible to control the shape or the occurrence position of the weld line. Further, even when the gate position is changed, the gate position, which is possible to be changed, is limited within a runner width, and therefore it is not possible to control the shape or the occurrence position of the weld line as intended.

### SUMMARY OF THE INVENTION

The present invention is made in consideration of the above-described problems, and has an object to control a shape or an occurrence position of a weld line generated on a molded product.

A molding mold according to the present invention includes: a runner to fill a molding material from a sprue to a cavity, the runner including a bent portion, in which a cross-sectional area of a flow channel passing through an inner side of the bent portion and a cross-sectional area of a flow channel passing through an outer side of the bent portion are different from each other in at least one region in the runner from the bent portion to the cavity.

Further, a projection is provided in the flow channel passing through the inner side of the bent portion.

Further, the projection is in proximity to the bent portion.

Further, the projection is provided in a nested manner.

Further, the projection has a width dimension that is approximately half a width of the runner, and a height lower than a height dimension of the runner.

A manufacturing method of a molded product according to the present invention is a manufacturing method of a molded product using a molding mold including a runner to fill a molding material from a sprue to a cavity, the runner including a bent portion, the manufacturing method including: providing a projection in one region of a flow channel passing through an inner side of the bent portion in at least one region in the runner from the bent portion to the cavity to thereby make a time when the molding material flowing through the inner side of the bent portion reaches the cavity and a time when the molding material flowing through an outer side of the bent portion reaches the cavity approximately the same while performing molding.

### BRIEF DESCRIPTION OF THE DRAWINGS

FIG. 1 is a perspective view of a molding mold according to a first embodiment;

FIG. 2 is a perspective view of a branch runner according to the first embodiment;

FIG. 3 is a plan view of the branch runner according to the first embodiment;

FIG. 4 is a partial perspective view of a molded product molded by the molding mold according to the first embodiment;

FIG. 5A and FIG. 5B are perspective views of branch runners according to other embodiments;

FIG. 6A, FIG. 6B, and FIG. 6C are perspective views of branch runners in which occurrence of a weld line cannot be controlled;

FIG. 7 is a perspective view of a conventional molding mold; and

FIG. 8 is a plan view of a branch runner of the conventional molding mold.

### DETAILED DESCRIPTION OF THE PREFERRED EMBODIMENTS

Hereinafter, preferred embodiments of a molding mold according to the present invention will be explained based on the drawings. Note that there will be explained the case when a molten resin is used as a molding material to be filled in the molding mold here.

### First Embodiment

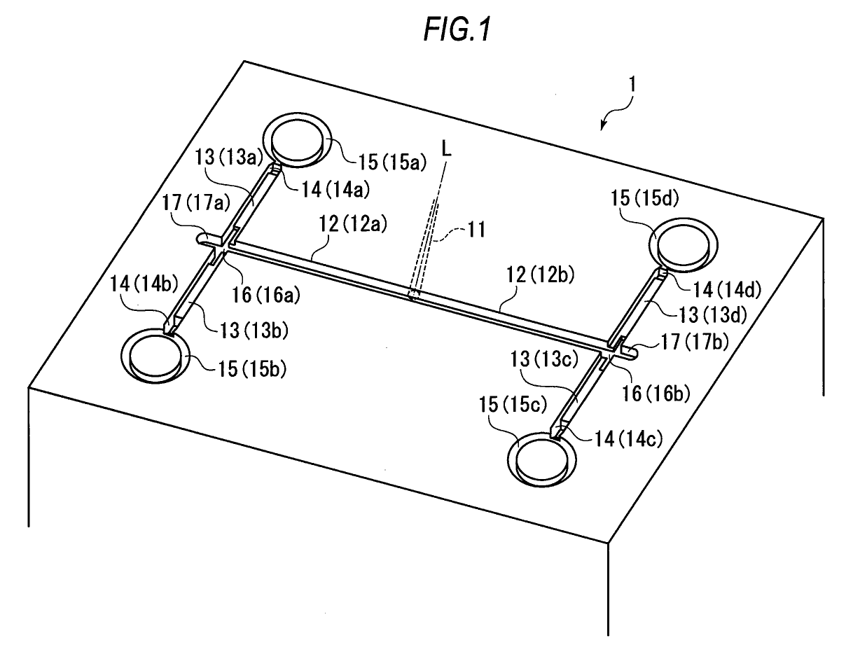

FIG. 1 is a perspective view of one mold of the molding mold according to a first embodiment. Here, there will be explained a molding mold (hereinafter referred to as a mold) molding, for example, ring shaped molded products by four-cavity molding.

As shown in FIG. 1, a mold 1 is structured including main runners 12 (12a, 12b), branch runners 13 (13a to 13d), gates 14 (14a to 14d), and cavities 15 (15a to 15d). Note that a sprue 11 provided in the other mold, which is not shown, is shown with dotted lines. The mold 1 according to this embodiment has each of components formed point-symmetrically around a center line L of the sprue 11.

The main runners 12 (12a, 12b) are flow channels with groove shapes in which a molten resin injected from the sprue 11 is allowed to flow into the branch runners 13. The main runners 12 (12a, 12b) are formed in a direction perpendicular to the sprue 11 provided in a vertical direction. Cross-sections of the flow channels of the main runners 12 are formed to be trapezoidal cross-sectional shapes having draft angles. Note that the cross-sectional shape will be referred to as an approximately rectangular cross-sectional shape hereinafter because the draft angle is small here. Further, a width W and a height H of the cross-sectional shapes of the main runners 12 are approximately the same in dimension. It is noted that the width W and the height H are not limited to be approximately the same in dimension, but they may be different in dimension.

Each of the branch runners 13 (13a to 13d) is formed at an end portion of each of the main runners 12 (12a, 12b) through each of bent portions 16 (16a, 16b). That is, each main runner 12 (12a, 12b) and each branch runner 13 (13a to 13d) intersect with each other at an angle of 90 degrees (perpendicular to each other), and the intersecting portion is structured as each bent portion 16 (16a, 16b). Accordingly, the mold 1 includes the bent portions 16 in between the runners. It is note that the bent portion is not limited to be formed perpendicularly, and it may be formed such that it is bent at a different angle not at an angle of 90 degrees, or it is bent in a curved manner.

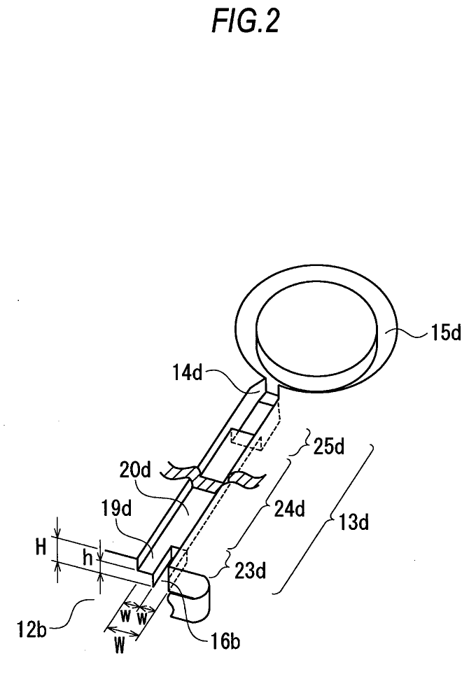

The branch runners 13 (13a to 13d) are flow channels with groove shapes in which the molten resin is allowed to flow from the bent portions 16 (16a, 16b) into the cavities 15 (15a to 15d). Here, cross-sectional shapes of the branch runners 13 (13a to 13d) may have the same height dimension as the height H of the main runners 12 basically, but they may not have the same width dimension as the width W of the main runners 12. Here, the cross-sectional shapes of the branch runners 13 (13a to 13d) are approximately rectangular cross-sectional shapes whose width W and height H are approximately the same in dimension similarly to those of the main runners 12, and the branch runners 13 (13a to 13d) have different cross-sectional shapes in at least one region along the flow channels. Note that each of the cross-sectional shapes of the branch runners 13 (13a to 13d) is the point-symmetrical cross-sectional shape around the above-described center line L. Note that details of each cross-sectional shape will be explained later with reference to FIG. 2. Each of the gates 14 (14a to 14d) is formed at an end of each of the branch runners 13 (13a to 13d).

The gates 14 (14a to 14d) are inflow ports to fill the molten resin into each of the cavities 15 (15a to 15d). A cross-sectional area of each of the gates 14 is formed to be small so that the resin filled in each of the cavities 15 does not flow back and article parts and non-article parts of the molded products molded are cut off easily. The cavities 15 (15a to 15d) are formed ahead of the gates 14 (14a to 14d) respectively.

The molten resin is filled in the cavities 15 (15a to 15d), and thereby molded products as manufactured articles are molded. The cavities 15 (15a to 15d) according to this embodiment are formed annularly with groove shapes in order to mold ring-shaped molded products. Further, each of the above-described gates 14 (14a to 14d) is connected to an outer surface of each of the cavities 15 (15a to 15d). Note that slug wells 17 (17a, 17b) are formed at extended portions from the main runners 12 (12a, 12b) in the mold 1 in order that the molten resin flows into the branch runners 13 (13a to 13d) smoothly.

As above, the main runners 12 (12a, 12b) are branched into a number of the branch runners 13 (13a to 13d), and each of the branch runners 13 (13a to 13d) is connected to each of the cavities 15 (15a to 15d). Thus, a large number of molded products can be molded at a time.

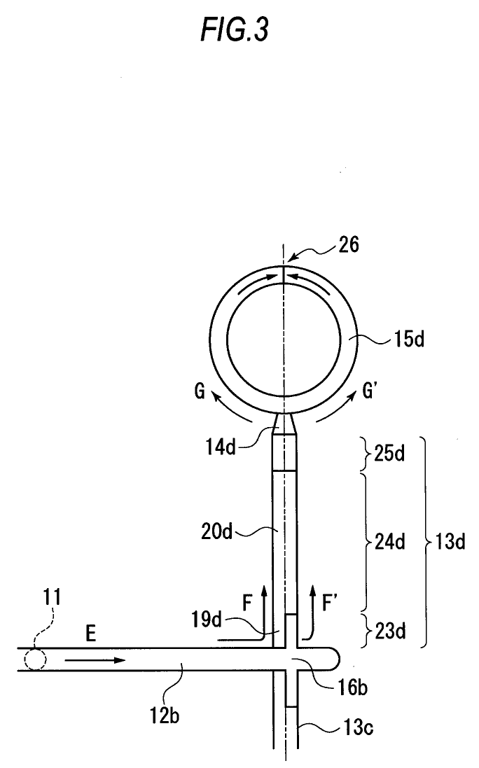

Next, details of the branch runners 13 (13a to 13d) will be explained with reference to FIG. 2 and FIG. 3. Here, among the plural branch runners 13 (13a to 13d), the branch runner 13d will be shown to be explained. FIG. 2 is a perspective view including the branch runner 13d. Further, FIG. 3 is a plan view including the branch runner 13d. As shown in FIG. 2, the cross-sectional shape of the branch runner 13d varies in a longitudinal direction, namely according to a position from the bent portion 16b to the gate 14d. To explain more specifically, the cross-sectional shape of the branch runner 13d varies in each of a first region 23d, a second region 24d, and a third region 25d along the longitudinal direction.

Firstly, the first region 23d is a region in proximity to the bent portion 16b, and has a length in the longitudinal direction set to be approximately ⅕ of the entire length of the branch runner 13d in the longitudinal direction. Further, the cross-sectional shape of the first region 23d differs in a flow channel passing through an inner side of the bent portion 16b to the second region 24d and a flow channel passing through an outer side of the bent portion 16b to the second region 24d. Concretely, there is provided a projection 19d or a protrusion having a width w, which is approximately ½ of the width W of the branch runner 13d, and a height h, which is approximately ⅔ of the height H of the branch runner 13d in the flow channel passing through the inner side of the bent portion 16b to the second region 24d. On the other hand, no projection is provided in the flow channel passing through the outer side of the bent portion 16b to the second region 24d. That is, by providing the projection 19d, the flow channel passing through the inner side of the bent portion 16b to the second region 24d is formed such that the height of the flow channel in the portion whose width dimension is approximately half the width of the branch runner 13d is lower than the height dimension of the branch runner 13d. Therefore, it is formed such that the cross-sectional area of the side where the molten resin is filled faster (one side from the middle of the width W of the branch runner 13d) is made to be small in the branch runner 13d.

The second region 24d is a region located between the first region 23d and the third region 25d, and has a length in the longitudinal direction set to be approximately ⅗ of the entire length of the branch runner 13d in the longitudinal direction. Further, there is provided a projection 20d or a projection portion having the width W of the branch runner 13d and the height h, which is approximately ⅔ of the height H of the branch runner 13d in the second region 24d.

The third region 25d is a region in proximity to the gate 14d, and has a length in the longitudinal direction set to be approximately ⅕ of the entire length of the branch runner 13d in the longitudinal direction. Further, no projection is provided in the third region 25d. That is, the groove cross-sectional shape of the third region 25d is the same as that of the flow channel of each main runner 12, and has the approximately rectangular cross-sectional shape having the width W and the height H. Here, the width W and the height H are approximately the same in dimension.

Here, the projection 19d provided in the first region 23d and the projection 20d provided in the second region 24d adhere to the branch runner 13d in a nested manner. Alternatively, the branch runner 13d itself is provided in a nested manner. Thus, the cross-sectional shape of the branch runner can be varied easily by replacing the projection 19d and the projection 20d with each other or replacing the branch runner 13d itself with another one according to types of the resin to be filled or molding conditions.

Next, details of filling the molten resin from the main runners 12 (12a, 12b) through the branch runners 13 (13a to 13d) and then the gates 14 (14a to 14d) into the cavities 15 (15a to 15d) will be explained with reference to FIG. 3. Here, among the plural cavities 15 (15a to 15d), the cavity 15d will be shown to be explained. Note that in each of the other cavities 15a to 15c, the molten resin is filled point-symmetrically around the center line L shown in FIG. 1.

Firstly, the molten resin injected from the sprue 11 passes through the main runner 12b as shown by an arrow E and flows into the bent portion 16b where the main runner 12b and the branch runner 13d intersect with each other. The resin flowed into the bent portion 16b flows in a bending manner from the main runner 12b to the branch runner 13d along the bent portion 16b. Note that although the resin also flows in a bending manner from the main runner 12b to the branch runner 13c, explanation thereof is omitted here. If a conventional mold is used at this time, the time for the resin to be filled varies in the inner side and the outer side of the bent portion 16b. That is, the resin flowing through the inner side of the bent portion 16b is filled faster, and the time for the resin flowing through the outer side of the bent portion 16b to be filled is slower because it takes a longer way.

However, in this embodiment as described above, the projection 19d is provided in the first region 23d of the branch runner 13d or the flow channel passing through the inner side of the bent portion 16b to the second region 24d. Accordingly, the resin flowing through the inner side of the bent portion 16b is hindered from flowing by the projection 19d, and thereby as shown by an arrow F in FIG. 3, the time for the resin to be filled becomes slow. On the other hand, no projection is provided in the flow channel passing through the outer side of the bent portion 16b to the second region 24d. Thus, the resin flowing through the outer side of the bent portion 16b is not hindered from flowing, and thereby as shown by an arrow F′ in FIG. 3, the time for the resin to be filled does not vary. Accordingly, since the projection 19d slows down the time for the resin flowing through the inner side of the bent portion 16b to be filled, the difference between the times for the resin flowing through the inner side of the bent portion 16b to be filled and the resin flowing through the outer side of the bent portion 16b to be filled is eliminated.

Thereafter, the resins flowing through the inner side and the outer side of the bent portion 16b pass through the first region 23d simultaneously and reach the second region 24d, the third region 25d, and the gate 14d while keeping the respective speeds coincident with each other. Between the resins reached the gate 14d, the resin flowing through the inner side of the bent portion 16b flows into the cavity 15d in an arrow G direction shown in FIG. 3, and the resin flowing through the outer side of the bent portion 16b flows into the cavity 15d in an arrow G′ direction shown in FIG. 3. Here, the resins that flow in the arrow G direction and the arrow G′ direction reach the cavity 15d simultaneously, and thereby the resins join at a joint line 26 coincident with the midpoint of the cavity 15d. That is, a weld line can be generated at a position symmetrical to the cavity 15d. Note that as for the other cavities 15a to 15c, weld lines can be generated similarly at positions symmetrical to the cavities 15a to 15c.

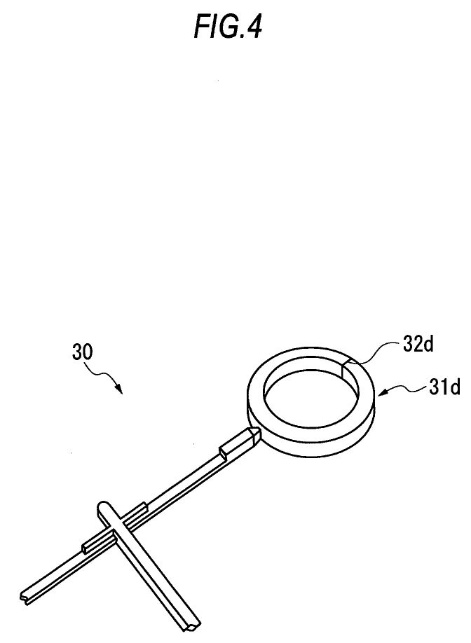

Next, a molded product molded by the mold according to this embodiment will be explained with reference to FIG. 4. FIG. 4 is a partial perspective view of the molded product molded. A molded product 30 shown in FIG. 4 is a portion of the molded product including a ring-shaped manufactured article 31d formed in the cavity 15d shown in FIG. 2 and FIG. 3. As shown in FIG. 4, the ring-shaped manufactured article 31d has a weld line 32d formed at the midpoint of the ring, namely at the side facing the gate in a diametrical direction.

As above, according to the molding mold in this embodiment, it is structured such that the cross-sectional area of the flow channel from the inner side of each bent portion 16 to each cavity 15 is made to be smaller than the cross-sectional area of the flow channel from the outer side of each bent portion 16 to each cavity 15 in each branch runner 13. Thus, flow balance of the resin can be adjusted in each branch runner 13 until the resin is filled in each cavity 15, and the weld line can be generated at the position coincident with the midpoint of each cavity 15.

Furthermore, the cross-sectional area of the flow channel from the inner side of each bent portion 16 to each cavity 15 is made to be different from the cross-sectional area of the flow channel from the outer side of each bent portion 16 to each cavity 15, and thereby it is possible to control the position of the weld line generated on the molded product, and the like as intended by the designer. In particular, the weld line is made to be generated on a parting line of the molded product or at a slit provided in terms of design or purposefully, and thereby it is possible to make the weld line not easily visible.

Further, in the molding mold according to this embodiment, each projection 19 is provided in proximity to each bent portion 16. Thus, the resin flowing through the inner side of each bent portion 16 is hindered instantly from flowing by each projection 19, resulting that the effect, which is to make the time for the resin to be filled in the inner side of each bent portion 16 slow, can be improved.

Note that there is explained only the case when each projection 19 is provided so that the cross-sectional area of the flow channel from the inner side of each bent portion 16 to each cavity 15 is smaller than the cross-sectional area of the flow channel from the outer side of each bent portion 16 to each cavity 15 in each branch runner 13 in the molding mold according to this embodiment, but the present invention is not limited to this case. For example, the groove of each branch runner 13 may be formed to be wider so that the cross-sectional area of the flow channel from the outer side of each bent portion 16 to each cavity 15 becomes larger than the cross-sectional area of the flow channel from the inner side of each bent portion 16 to each cavity 15. That is, it may be formed such that the cross-sectional area of the side where the molten resin is filled more slowly (the other side from the middle of the width W of each branch runner 13) is made to be large in each branch runner 13.

### Second Embodiment

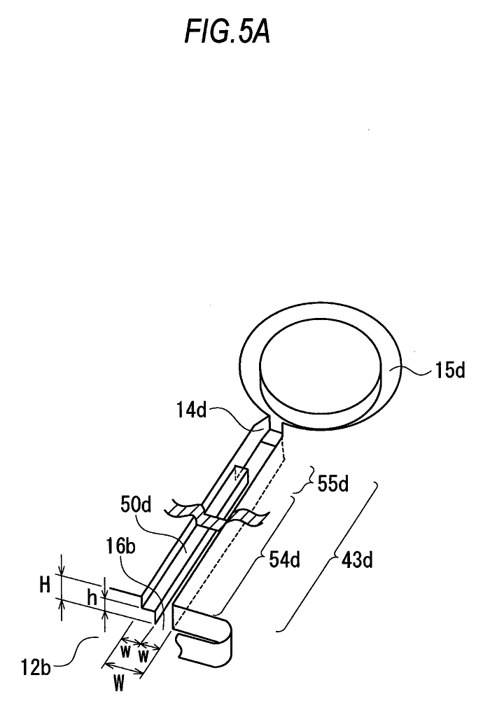

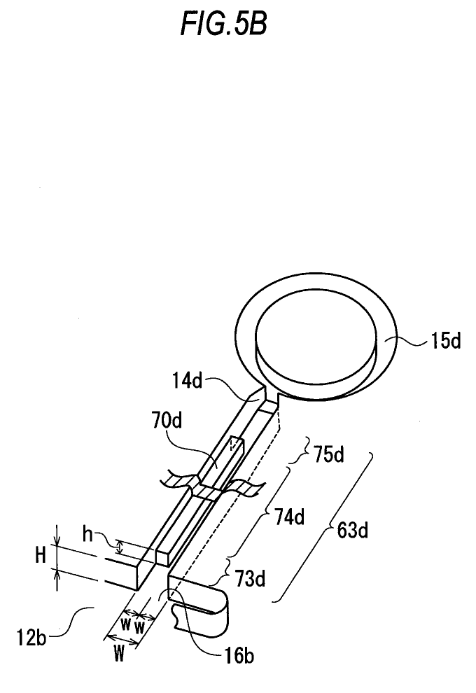

Next, there will be explained details of a cross-sectional shape of a branch runner according to a second embodiment with reference to FIG. 5A. Here, similarly to the first embodiment, among the branch runners, the portion corresponding to the branch runner 13d shown in FIG. 1 will be shown to be explained. FIG. 5A is a perspective view of a branch runner 43d. Other components other than the branch runner 43d have the same structure as those of the first embodiment, and therefore the same reference numerals and symbols are given to the other components and explanation thereof is omitted.

As shown in FIG. 5A, the cross-sectional shape of the branch runner 43d varies in a longitudinal direction, namely according to a position from the bent portion 16b to the gate 14d. To explain more specifically, the cross-sectional shape of the branch runner 43d varies in each of a first region 54d and a second region 55d along the longitudinal direction.

Firstly, the first region 54d is a region in proximity to the bent portion 16b, and has a length in the longitudinal direction set to be approximately ⅘ of the entire length of the branch runner 43d in the longitudinal direction. Further, the cross-sectional shape of the first region 54d differs in a flow channel passing through an inner side of the bent portion 16b to the second region 55d and a flow channel passing through an outer side of the bent portion 16b to the second region 55d. Concretely, there is provided a projection 50d having a width w, which is approximately ½ of a width W of the branch runner 43d, and a height h, which is approximately ⅔ of a height H of the branch runner 43d in the flow channel passing through the inner side of the bent portion 16b to the second region 55d. On the other hand, no projection is provided in the flow channel passing through the outer side of the bent portion 16b to the second region 55d. That is, by providing the projection 50d, the flow channel passing through the inner side of the bent portion 16b to the second region 55d is formed such that the height of the flow channel in the portion whose width dimension is approximately half the width of the branch runner 43d is lower than the height dimension of the branch runner 43d. Thus, it is formed such that the cross-sectional area of the side where the molten resin is filled faster (one side from the middle of the width W of the branch runner 43d) is made to be small in the branch runner 43d.

The second region 55d is a region in proximity to the gate 14d, and has a length in the longitudinal direction set to be approximately ⅕ of the entire length of the branch runner 43d in the longitudinal direction. Further, no projection is provided in the second region 55d. That is, the groove cross-sectional shape of the second region 55d is the same as that of the flow channel of each main runner 12, and has the approximately rectangular cross-sectional shape having the width W and the height H. Here, the width W and the height H are approximately the same in dimension.

Note that the projection 50d provided in the first region 54d is. the one that is replaced with the projection 19d and the projection 20d in a nested manner, or the one that is replaced with the branch runner 13d itself in the first embodiment.

As above, in the molding mold according to this embodiment, it is structured such that the cross-sectional area of the flow channel from the inner side of each bent portion 16 to each cavity 15 is made to be smaller than the cross-sectional area of the flow channel from the outer side of each bent portion 16 to each cavity 15 in each branch runner 43. Thus, similarly to the first embodiment, flow balance of the resin can be adjusted in each branch runner 43 until the resin is filled in each cavity 15, and the weld line can be generated at the position coincident with the midpoint of each cavity 15.

### Third Embodiment

Next, there will be explained details of a cross-sectional shape of a branch runner according to a third embodiment with reference to FIG. 5B. Here, similarly to the first embodiment, among the branch runners, the portion corresponding to the branch runner 13d shown in FIG. 1 will be shown to be explained. FIG. 5B is a perspective view of a branch runner 63d. Other components other than the branch runner 63d have the same structure as those of the first embodiment, and therefore the same reference numerals and symbols are given to the other components and explanation thereof is omitted.

As shown in FIG. 5B, the cross-sectional shape of the branch runner 63d varies in a longitudinal direction, namely according to a position from the bent portion 16b to the gate 14d. To explain more specifically, the cross-sectional shape of the branch runner 63d varies in each of a first region 73d, a second region 74d, and a third region 75d along the longitudinal direction.

Firstly, the first region 73d is a region in proximity to the bent portion 16b, and has a length in the longitudinal direction set to be approximately ⅕ of the entire length of the branch runner 63d in the longitudinal direction. No projection is provided in the first region 73d. That is, the groove cross-sectional shape of the first region 73d is the same as that of the flow channel of each main runner 12, and has the approximately rectangular cross-sectional shape having the width W and the height H. Here, the width W and the height H are approximately the same in dimension.

The second region 74d is a region located between the first region 73d and the third region 75d, and has a length in the longitudinal direction set to be approximately 3/5 of the entire length of the branch runner 63d in the longitudinal direction. Further, the cross-sectional shape of the second region 74d differs in a flow channel passing through an inner side of the bent portion 16b to the third region 75d and a flow channel passing through an outer side of the bent portion 16b to the third region 75d. Concretely, there is provided a projection 70d having a width w, which is approximately ½ of a width W of the branch runner 63d and a height h, which is approximately ⅔ of a height H of the branch runner 63d in the flow channel passing through the inner side of the bent portion 16b to the third region 75d. On the other hand, no projection is provided in the flow channel passing through the outer side of the bent portion 16b to the third region 75d. That is, by providing the projection 70d, the flow channel passing through the inner side of the bent portion 16b to the third region 75d is formed such that the height of the flow channel in the portion whose width dimension is approximately half the width of the branch runner 63d is lower than the height dimension of the branch runner 63d. Thus, it is formed such that the cross-sectional area of the side where the molten resin is filled faster (one side from the middle of the width W of the branch runner 63d) is made to be small in the branch runner 63d.

The third region 75d is a region in proximity to the gate 14d, and has a length in the longitudinal direction set to be approximately ⅕ of the entire length of the branch runner 63d in the longitudinal direction. Further, no projection is provided in the third region 75d. That is, the cross-sectional shape of the third region 75d is the same as that of the flow channel of each main runner 12, and has the approximately rectangular cross-sectional shape having the width W and the height H.

Note that the projection 70d provided in the second region 74d is the one that is replaced with the projection 19d and the projection 20d in a nested manner, or the one that is replaced with the branch runner 13d itself in the first embodiment.

As above, in the molding mold according to this embodiment, it is structured such that the cross-sectional area of the flow channel from the inner side of each bent portion 16 to each cavity 15 is made to be smaller than the cross-sectional area of the flow channel from the outer side of each bent portion 16 to each cavity 15 in each branch runner 63. Thus, similarly to the first embodiment, flow balance of the resin can be adjusted in each branch runner 63 until the resin is filled in each cavity 15, and the weld line can be generated at the position coincident with the midpoint of each cavity 15.

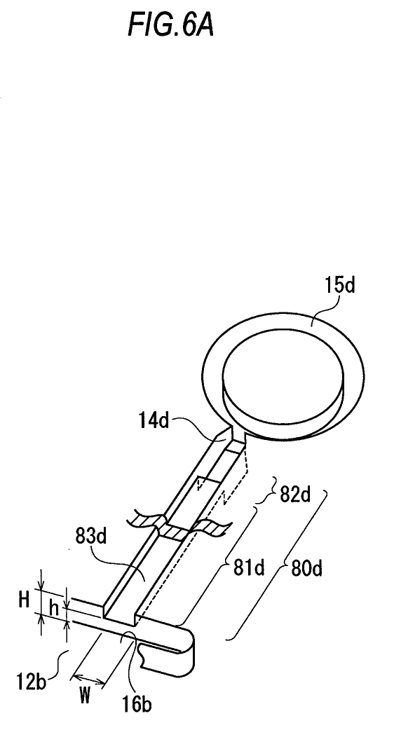

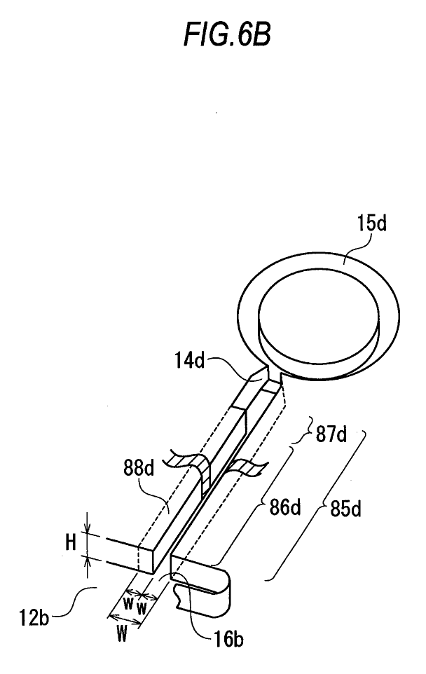

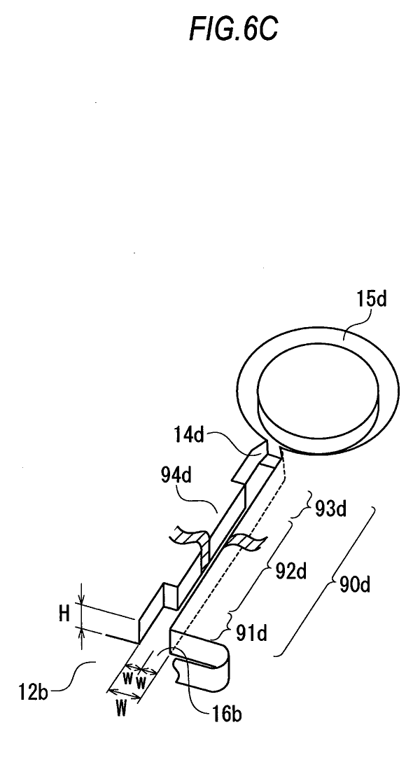

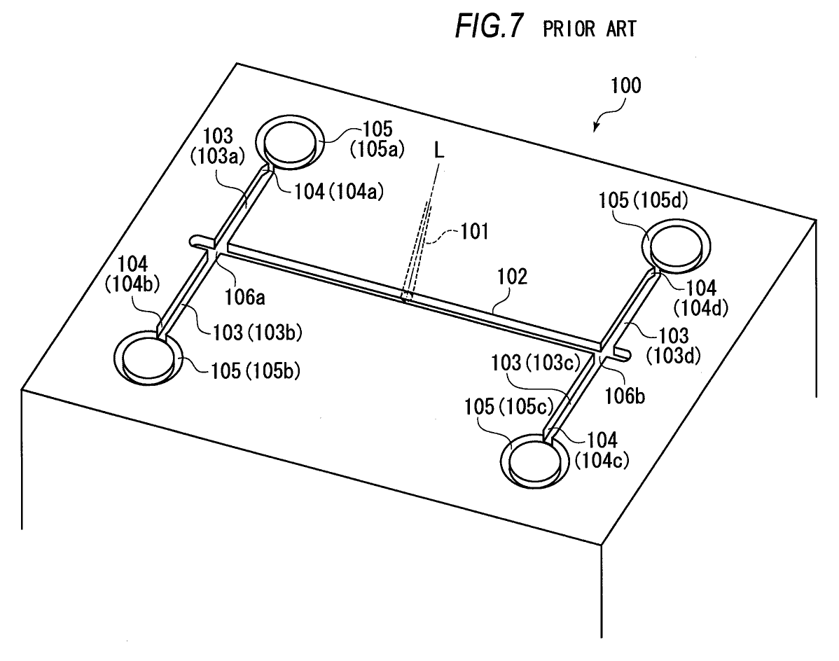

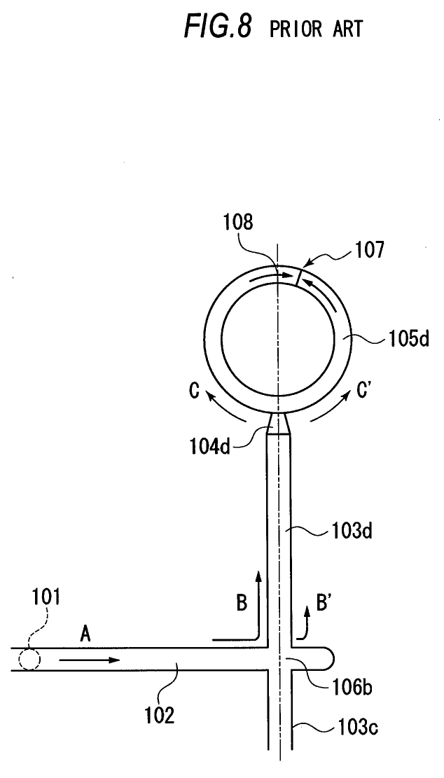

In the above-described first to third embodiments, there are explained the runners in which flow balance of the resin is adjusted in the branch runner and thus the weld line can be generated at the position coincident with the midpoint of each cavity 15. Hereinafter, there will be explained examples in which occurrence of the weld line cannot be controlled with reference to FIG. 6A to FIG. 6C.

FIG. 6A is a perspective view showing one example of a branch runner 80d in which occurrence of the weld line cannot be controlled. Note that the same reference numerals and symbols as those of the first embodiment are given to components other than the branch runner 80d. A first region 81d and a second region 82d are formed along a longitudinal direction in the branch runner 80d shown in FIG. 6A.

The first region 81d has a length in the longitudinal direction set to be approximately ⅘ of the entire length of the branch runner 80d in the longitudinal direction. Further, a projection 83d having a width W of the branch runner 80d and a height h, which is approximately ⅔ of a height H of the branch runner 80d is provided in the first region 81d. That is, the first region 81d is provided with a groove having the width W of the branch runner 80d and a height, which is approximately ⅓ of the height H of the branch runner 80d.

The second region 82d is a region in proximity to the gate 14d, and has a length in the longitudinal direction set to be approximately ⅕ of the entire length of the branch runner 80d in the longitudinal direction. Further, no projection is provided in the second region 82d. That is, the groove cross-sectional shape of the second region 82d is the same as that of the flow channel of each main runner 12, and has the approximately rectangular cross-sectional shape having the width W and the height H. Here, the width W and the height H are approximately the same in dimension.

In the branch runner 80d shown in FIG. 6A as above, the cross-sectional area of the flow channel from an inner side of the bent portion 16b to the cavity 15d and the cross-sectional area of the flow channel from an outer side of the bent portion 16b to the cavity 15d are always the same, and therefore, the difference between the time for the resin to be filled in the inner side of the bent portion 16b and the time for the resin to be filled in the outer side of the bent portion 16b cannot be eliminated.

Next, FIG. 6B is a perspective view showing one example of a branch runner 85d in which occurrence of the weld line cannot be controlled. Note that the same reference numerals and symbols as those of the first embodiment are given to components other than the branch runner 85d. A first region 86d and a second region 87d are formed along a longitudinal direction in the branch runner 85d shown in FIG. 6B.

Firstly, the first region 86d is a region in proximity to the bent portion 16b, and has a length in the longitudinal direction set to be approximately ⅘ of the entire length of the branch runner 85d in the longitudinal direction. The first region 86d is structured only by a flow channel passing through an outer side of the bent portion 16b to the second region 87d, and a flow channel passing through an inner side of the bent portion 16b to the second region 87d, which exists in the first to third embodiments, does not exist in the first region 86d. That is, as shown in FIG. 6B, a projection 88d having a width w, which is approximately ½ of a width W of the branch runner 85d and a height H of the branch runner 85d is provided in the first region 86d, and thereby the flow channel passing through the inner side of the bent portion 16b to the second region 87d is blocked.

The second region 87d is a region in proximity to the gate 14d, and has a length in the longitudinal direction set to be approximately ⅕ of the entire length of the branch runner 85d in the longitudinal direction. Further, no projection is provided in the second region 87d. That is, the cross-sectional shape of the second region 87d is the same as that of the flow channel of each main runner 12, and has the approximately rectangular cross-sectional shape having the width W and the height H. Here, the width W and the height H are approximately the same in dimension.

Since the flow channel from the inner side of the bent portion 16b to the cavity 15d does not exist in the branch runner 85d shown in FIG. 6B as above, the difference between the time for the resin to be filled in the inner side of the bent portion 16b and the time for the resin to be filled in the outer side of the bent portion 16b cannot be eliminated.

Next, FIG. 6C is a perspective view showing one example of a branch runner 90d in which occurrence of the weld line cannot be controlled. Note that the same reference numerals and symbols as those of the first embodiment are given to components other than the branch runner 90d. A first region 91d, a second region 92d, and a third region 93d are formed along a longitudinal direction in the branch runner 90d shown in FIG. 6C.

Firstly, the first region 91d is a region in proximity to the bent portion 16b, and has a length in the longitudinal direction set to be approximately ⅕ of the entire length of the branch runner 90d in the longitudinal direction. Further, no projection is provided in the first region 91d. That is, the groove cross-sectional shape of the first region 91d is the same as that of the flow channel of each main runner 12, and has the approximately rectangular cross-sectional shape having the width W and the height H. Here, the width W and the height H are approximately the same in dimension.

Further, the second region 92d is a region located between the first region 91d and the third region 93d, and has a length in the longitudinal direction set to be approximately ⅗ of the entire length of the branch runner 90d in the longitudinal direction. The second region 92d is structured only by a flow channel passing through an outer side of the bent portion 16b to the third region 93d, and a flow channel passing through an inner side of the bent portion 16b to the third region 93d, which exists in the first to third embodiments, does not exist in the second region 92d. That is, as shown in FIG. 6C, a projection 94d having a width w, which is approximately ½ of a width W of the branch runner 90d and a height H of the branch runner 90d is provided in the second region 92d, and therefore the flow channel passing through the inner side of the bent portion 16b to the third region 93d is blocked.

The third region 93d is a region in proximity to the gate 14d, and has a length in the longitudinal direction set to be approximately ⅕ of the entire length of the branch runner 90d in the longitudinal direction. Further, no projection is provided in the third region 93d. That is, the cross-sectional shape of the third region 93d is the same as that of the flow channel of each main runner 12, and has the approximately rectangular cross-sectional shape having the width W and the height H. Here, the width W and the height H are approximately the same in dimension.

Since the flow channel from the inner side of the bent portion 16b to the cavity 15d does not exist partly in the branch runner 90d shown in FIG. 6C as above, the difference between the time for the resin to be filled in the inner side of the bent portion 16b and the time for the resin to be filled in the outer side of the bent portion 16b cannot be eliminated.

According to FIG. 6A to 6C, which are described above, in order to make the cross-sectional area of the flow channel from the inner side of each bent portion 16 to each cavity 15 and the cross-sectional area of the flow channel from the outer side of each bent portion 16 to each cavity 15 in the brunch runner different from each other, it is necessary to make the respective cross-sectional areas different from each other at least under the situation where the flow channel includes the cross-sectional area of the side where the molten resin is filled faster (one side from the middle of the width W of the branch runner 13d) in the branch runner.

Note that although only the mold in which the resin as the molding material is used for molding is explained in the explanation of the first to third embodiments, it may be the mold in which a molding material such as a zinc die-cast or an aluminum alloy is used for molding.

Further, in the explanation of the first to third embodiments, only the case when the cross-sectional area of the side where the molten resin is filled faster (one side from the middle of the width of the branch runner) in the runner is made to be different by varying a height h direction of the projection is explained, but the cross-sectional area of the side where the resin is filled faster may be made to be different by narrowing the width w of the projection.

Further, only the case when four molded products are molded by multi-cavity molding in the molding mold according to the first to third embodiments is explained, but as long as the molding mold is structured so that the runner and the runner are connected in a bending manner, it may be by, for example, two-cavity molding or eight-cavity molding, or the like.

Also, in the explanation of the first to third embodiments, only the case when the ring-shaped molded product is molded is explained, but the present invention can be applied to the mold in which the weld line is generated by the molding materials being joined for molding, for example, a molded product having a hole, and the like.

Further, according to the first to third embodiments, only the molding mold structured by the main runners and the branch runners is explained, but the present invention is not limited to this case. For example, the molding mold may be structured such that the branch runner (first branch runner) is further connected to the branch runner (second branch runner) through the bent portion. In such a case, it is structured such that the cross-sectional area of the flow channel from the inner side of the bent portion and the cross-sectional area of the flow channel from the outer side of the bent portion are different from each other in both of the branch runners respectively when necessary.

According to the present invention, the cross-sectional area of the flow channel passing through the inner side of the bent portion and the cross-sectional area of the flow channel passing through the outer side of the bent portion are different from each other in at least one region in the runner from the bent portion to the cavity, and therefore, it becomes possible to control the shape and the occurrence position of the weld line that occurs on the molded product without changing the molding conditions, the thickness of the molded product itself, or a gate position, or the like. Accordingly, the shape and the occurrence position of the weld line can be generated as intended, with the result that it is possible to make the weld line less visible, and improve value of the manufactured article of the molded product.

Further, according to the present invention, for example, the projection is provided in the flow channel passing through the inner side of the bent portion. Thus, the simple structure can make the cross-sectional areas of the flow channel passing through the inner side of the bent portion and the flow channel passing through the outer side of the bent portion different from each other.

Also, according to the present invention, for example, since the projection is in proximity to the bent portion, the resin flowing through the inner side of the bent portion is hindered from flowing instantly, and thus it is possible to make the time for the resin to be filled in the inner side of the bent portion sufficiently slow.

Also, according to the present invention, for example, since the projection is provided in a nested manner, the projection can be replaced with another projection easily, and thus the cross-sectional shape of the runner can be varied easily according to types of the molding material or the molding conditions.

Also, according to the present invention, for example, the projection has the width dimension that is approximately half the width of the runner, and the height lower than the height dimension of the runner, resulting that the preferred weld line can be generated.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A molding mold comprising:
a runner to fill a molding material from a sprue to a cavity, the runner including a bent portion, and wherein
a cross-sectional area of a flow channel passing through an inner side of the bent portion and a cross-sectional area of a flow channel passing through an outer side of the bent portion are different from each other in at least one region in the runner from the bent portion to the cavity.

2. The molding mold according to claim 1, wherein
a projection is provided in the flow channel passing through the inner side of the bent portion.

3. The molding mold according to claim 2, wherein
the projection is in proximity to the bent portion.

4. The molding mold according to claim 2, wherein
the projection is provided in a nested manner.

5. The molding mold according to claim 3, wherein
the projection is provided in a nested manner.

6. The molding mold according to claim 2, wherein
the projection has a width dimension that is approximately half a width of the runner, and a height lower than a height dimension of the runner.

7. The molding mold according to claim 3, wherein
the projection has the width dimension that is approximately half the width of the runner, and the height lower than the height dimension of the runner.

8. The molding mold according to claim 4, wherein
the projection has the width dimension that is approximately half the width of the runner, and the height lower than the height dimension of the runner.

9. The molding mold according to claim 5, wherein
the projection has the width dimension that is approximately half the width of the runner, and the height lower than the height dimension of the runner.

10. A manufacturing method of a molded product using a molding mold comprising a runner to fill a molding material from a sprue to a cavity, the runner including a bent portion, the manufacturing method comprising:
providing a projection in one region in a flow channel passing through an inner side of the bent portion in at least one region in the runner from the bent portion to the cavity to thereby make a time when the molding material flowing through the inner side of the bent portion reaches the cavity and a time when the molding material flowing through an outer side of the bent portion reaches the cavity approximately the same while performing molding.
